(19) United States
(12) Patent Application Publication
(10) Pub. No.: US 2018/0082695 A1
(43) Pub. Date: Mar. 22, 2018

(54) ADAPTIVE ARITHMETIC CODING OF AUDIO CONTENT

(71) Applicants: DOLBY LABORATORIES LICENSING CORPORATION, San Francisco, CA (US); DOLBY INTERNATIONAL AB, Amsterdam (NL)

(72) Inventors: Xuejing SUN, Beijing (CN); Dong SHI, Shanghai (CN); Janusz KLEJSA, Stockholm (SE)

(73) Assignees: DOLBY LABORATORIES LICENSING CORPORATION, San Francisco, CA (US); DOLBY INTERNATIONAL AB, Amsterdam (NL)

(21) Appl. No.: 15/564,125

(22) PCT Filed: Apr. 13, 2016
(86) PCT No.: PCT/US16/27362

§ 371 Date: Oct. 3, 2017

Related U.S. Application Data
(60) Provisional application No. 62/149,938, filed on Apr. 20, 2015.

(30) Foreign Application Priority Data
Apr. 14, 2015 (CN) 201510175941.3

(51) Int. Cl. G10L 19/00; G10L 19/20; G10L 19/02

(52) U.S. Cl. CPC G10L 19/0017; G10L 19/0204; G10L 19/20

(57) ABSTRACT

Disclosed is a system and computer program product of encoding audio content and corresponding method. The method includes determining a characteristic of the audio content, the characteristic of the audio content including at least one of a type or a property of the audio content. Also the method includes classifying the audio content based on the characteristic of the audio content and determining probabilities for multiple predefined audio coding symbols associated with the audio content by calculating a probability for each of the audio coding symbols based on the result of the classification, the probability for an audio coding symbol indicating a frequency at which the audio coding symbol occurs in the audio content. Further, the method encoded the audio content based on the audio coding symbols and the corresponding probabilities to obtain a code value, the code value representing a compression coding format of the audio content.

### CROSS-REFERENCE TO RELATED APPLICATIONS

This application claims priority to Chinese Patent Application No. 201510175941.3 filed on Apr. 14, 2015 and claims the benefit of the U.S. Provisional Patent Application No. 62/149,938, filed on Apr. 20, 2015, both of which are hereby incorporated by reference in their entirety.

### TECHNOLOGY

Example embodiments disclosed herein generally relate to adaptive arithmetic coding of audio content, and more specifically, to a method and system for encoding audio content, and a method and system for decoding audio content.

### BACKGROUND

Audio coding is a process for compressing or decompressing a digital audio signal so as to represent the audio signal with a small amount of bits while retaining its quality. Entropy coding is an example of a lossless audio coding technique. More specifically, entropy coding utilizes statistical models of a digital signal to assign variable length codewords to symbols representing the digital signal. For example, some entropy coding methods assign a unique prefix-free code to each unique symbol that occurs in input data according to probabilities of the symbols (e.g., Huffman coding). The length of each codeword representing a symbol is approximated proportionally to the negative logarithm of the probability of the corresponding symbol occurring in the input data. Therefore, the most common symbols use the shortest codes. This strategy reduces the average bit-rate needed to code the signal symbols.

Arithmetic coding (AC) is an example of an entropy coding method. Compared to other entropy coding methods (e.g., Huffman coding), arithmetic coding provides more flexibility by separating coding and signal source modeling, and often achieves a higher compression ratio. While Huffman coding typically employs a static probabilistic model (e.g., a probability mass function of the symbols to be coded), context adaptive arithmetic coding methods, such as context-adaptive binary arithmetic coding (CABAC), employ adaptive probability models. CABAC updates according to already-coded symbols in the neighborhood of the current symbol to be encoded. Such an approach can be prone to modeling errors due to the limited information provided by neighborhood symbols, which consequently hinder the efficiency of the audio compression. Thus, it is desired to propose an audio coding method that achieves a higher compression ratio by improving upon the existing adaptive arithmetic coding methods. In addition, the process of adaptation of the probabilistic model used by an arithmetic codec is typically associated with relatively large computational complexity. For example, in some situations, it may be required that the probabilistic model needs to be updated for every encoded symbol which may lead to a significant computational burden. Therefore, it would be beneficial to have an adaptation process that reduces the number of computations that need to be performed in the course of the adaptation of the model. In particular, some arithmetic operations are typically associated with a large computational cost (e.g., integer divisions). Therefore, it is beneficial to reduce number of divisions in the course of the update of the model.

### SUMMARY

In general, example embodiments disclosed herein propose a method and system of encoding audio content, and a method and system of decoding audio content.

In one aspect, example embodiments disclosed herein provide a method of encoding audio content. The method includes determining a characteristic of the audio content, the characteristic of the audio content including at least one of a type or a property of the audio content. The method also includes classifying the audio content based on the determined characteristic of the audio content, and determining probabilities for multiple predefined audio coding symbols associated with the audio content by calculating a probability for each of the audio coding symbols based on the result of the classification, the probability for an audio coding symbol indicating a frequency at which the audio coding symbol occurs in the audio content. The method further includes encoding the audio content based on the predefined audio coding symbols and the corresponding probabilities to obtain a code value, the code value representing a compression coding format of the audio content. Embodiments in this regard further comprise a corresponding computer program product.

In a second aspect, example embodiments disclosed herein provide a method of decoding audio content. The method includes obtaining a code value and a result of classification of the audio content, the code value representing a compression coding format of the audio content, the result of the classification being determined based on a characteristic of the audio content including at least one of a type or a property of the audio content. The method also includes determining probabilities for multiple predefined audio coding symbols associated with the audio content by calculating a probability for each of the audio coding symbols based on the result of the classification, the probability for an audio coding symbol indicating a frequency at which the audio coding symbol occurs in the audio content. The method further includes decoding the code value based on the predefined audio coding symbols and the corresponding probabilities to obtain audio coding symbols representing the audio content. Embodiments in this regard further include a corresponding computer program product.

In a third aspect, example embodiments disclosed herein provide a system of encoding audio content. The system includes a characteristic determination unit configured to determine a characteristic of the audio content, the characteristic of the audio content including at least one of a type or a property of the audio content. The system also includes a content classification unit configured to classify the audio content based on the determined characteristic of the audio content, and a probability determination unit configured to determine probabilities for multiple predefined audio coding symbols associated with the audio content by calculating a probability for each of the audio coding symbols based on the result of the classification, the probability for an audio coding symbol indicating a frequency at which the audio coding symbol occurs in the audio content. The system further includes an encoding unit configured to encode the audio content based on the predefined audio coding symbols and the corresponding probabilities to obtain a code value, the code value representing a compression coding format of the audio content.

In a fourth aspect, example embodiments disclosed herein provide a system of decoding audio content. The system includes an obtaining unit configured to obtain a code value and a result of classification of the audio content, the code value representing a compression coding format of the audio content, the result of the classification being determined based on a characteristic of the audio content including at least one of a type or a property of the audio content. The system also includes a probability determination unit configured to determine probabilities for multiple predefined audio coding symbols associated with the audio content by calculating a probability for each of the audio coding symbols based on the result of the classification, the probability for an audio coding symbol indicating a frequency at which the audio coding symbol occurs in the audio content. The system further includes a decoding unit configured to decode the code value based on the predefined audio coding symbols and the corresponding probabilities to obtain audio coding symbols representing the audio content.

Through the following description, it would be appreciated that in accordance with example embodiments disclosed herein, the probabilities of audio coding symbols used to encode input audio content are determined based on the characteristic-based classification of the audio content, and therefore the probability determination can be content-specific, which can improve coding efficiency. Other advantages achieved by example embodiments disclosed herein will become apparent through the following descriptions.

### DESCRIPTION OF DRAWINGS

Through the following detailed description with reference to the accompanying drawings, the above and other objectives, features and advantages of example embodiments disclosed herein will become more comprehensible. In the drawings, several example embodiments disclosed herein will be illustrated in an example and non-limiting manner, wherein:

FIG. 1 illustrates a flowchart of a method of encoding audio content in accordance with an example embodiment disclosed herein;

FIG. 2A illustrates a block diagram of an audio encoding system in accordance with an example embodiment disclosed herein;

FIG. 2B illustrates a block diagram of an audio encoding system in accordance with another example embodiment disclosed herein;

FIG. 3 illustrates a flowchart of a method of decoding audio content in accordance with an example embodiment disclosed herein;

FIG. 4A illustrates a block diagram of an audio decoding system in accordance with an example embodiment disclosed herein;

FIG. 4B illustrates a block diagram of an audio decoding system in accordance with another example embodiment disclosed herein;

FIG. 5 illustrates a block diagram of a system of encoding audio content in accordance with one example embodiment disclosed herein;

FIG. 6 illustrates a block diagram of a system of decoding audio content in accordance with one example embodiment disclosed herein; and

FIG. 7 illustrates a block diagram of an example computer system suitable for implementing example embodiments disclosed herein.

Throughout the drawings, the same or corresponding reference symbols refer to the same or corresponding parts.

### DESCRIPTION OF EXAMPLE EMBODIMENTS

Principles of example embodiments disclosed herein will now be described with reference to various example embodiments illustrated in the drawings. It should be appreciated that depiction of these embodiments is only to enable those skilled in the art to better understand and further implement example embodiments disclosed herein, not intended for limiting the scope disclosed herein in any manner.

Some basic notations of arithmetic coding (AC) are first introduced before illustrating the solution proposed herein. It is noted that the term “coding” used herein refers to both encoding and decoding processes.

At the encoding side, let S={s₁, s₂, . . . , S_{N}} represent a sequence of N symbols provided to the arithmetic encoder. Without loss generality, it may be assumed that each symbol may take M different values in the sequence S. Each symbol in the sequence S is referred to as an instance of one of the M different symbols hereinafter. In general, the N symbols may be random. In the case where the arithmetic coding is applied to audio encoding, the sequence of N symbols may be a series of symbols obtained after a pre-processing of audio content (e.g., quantization). Suppose that M different audio coding symbols are consecutive integers {0, 1, . . . , M−1}, then a symbol sₖ (k=1, 2, . . . , N) takes an integer value from the set {0, 1, . . . , M−1} with a probability p(m), which is represented as below:

p(m)=Prob{sₖ=m}, (1)

where m=0, 1, 2, . . . , M−1, and M and N are both integers.

Hereinafter, each element in the set used for coding of the audio content (for example, an integer symbol in the set {0, 1, . . . , M−1} in this case) is referred to as an audio coding symbol, and each element in the sequence S that is obtained from the audio content is referred to as an instance of a respective audio coding symbol.

In addition, a cumulative distribution function (CDF) is defined as:

$$c ( m ) = {\sum }_{s = 0}^{m - 1} p ( s ) \qquad ( 2 )$$

where m=0, 1, 2, . . . , M, and c(M)=1.

The arithmetic encoding process essentially consists of generating a sequence of nested intervals as below:

Φₖ(S)=[αₖ, βₖ), (3)

where k=0, 1, . . . , N, 0≦αₖ≦αₖ₊₁, and βₖ₊₁≦βₖ≦1.

Alternatively, an interval can be represented in the form |b, l>, where b denotes the base or starting point of the interval and l denotes the length of the interval, namely, l=β−α. Then the encoding process is defined by the following recursive equations:

Φ₀(S)=[α₀, β₀)=|b₀, l₀>=|0,1>, (4)

Φₖ(S)=[αₖ, βₖ)=[αₖ₋₁+c(sₖ)(βₖ₋₁−αₖ₋₁), αₖ₋₁+c(sₖ₊₁)(βₖ₋₁−αₖ₋₁)), (5)

Φₖ(S)=|bₖ, lₖ>=|bₖ₋₁+c(sₖ)lₖ₋₁, p(sₖ)lₖ₋₁>. (6)

The process runs recursively for all symbols in the input sequence S.

The final task in arithmetic encoding is to define a code value \hat{v} that will represent the sequence S. The code value will be determined from the range of the high and low values in the final nested interval as a point belonging to the interval. The position of the point may be then represented by a real fractional value. In some embodiments, the interval defines the codeword, therefore any point from the nested interval determined for the final symbol in the input sequence can be mapped to the codeword, that is, \hat{v} εΦₙ(S)

The decoding process starts with the code value \hat{v} obtained from the encoder. Starting with \hat{v}₁=\hat{v}, ŝₖ is sequentially determined from \hat{v}ₖ, and then \hat{v}ₖ₊₁ is computed from ŝₖ and \hat{v}ₖ, which are represented in the following Equations (7)-(9). The probability and cumulative distribution function of each symbol are also estimated before computating ŝₖ and \hat{v}ₖ.

$$\begin{matrix}{\hat{v}}_{1} = \hat{v} , & ( 7 ) \\ {\hat{s}}_{k} ( \hat{v} ) = \{ s : c ( s ) \leq {\hat{v}}_{k} < c ( s + 1 ) \} , k = 1 , 2 , … , N , & ( 8 ) \\ {\hat{v}}_{k + 1} = \frac{{\hat{v}}_{k} - c ( {\hat{s}}_{k} ( \hat{v} ) )}{p ( {\hat{s}}_{k} ( \hat{v} ) )} , k = 1 , 2 , … , N - 1. & ( 9 )\end{matrix}$$

The decoding process runs recursively to obtain the decoded sequence Ŝ(\hat{v})={ŝ₁(\hat{v}), ŝ₂(\hat{v}), . . . , ŝ_{N}(\hat{v})}.

It can be seen from both the encoding and decoding processes that probability estimation constitutes a core part of arithmetic coding, which impacts complexity and coding efficiency of the final output. The process of probability estimation is also referred to as probabilistic modeling. In some conventional approaches, probabilities of the audio coding symbols are simply set to predefined values (e.g., values of a trained probability mass function) and remain fixed in the course of the coding process. Since the audio signals may be regarded as non-stationary, a predefined fixed probability mass function would describe the statistical properties of the sequence of symbols inaccurately, which may result in an increased length of codeword and thus would lead to decreased coding efficiency. In some other conventional approaches, the probability or CDF of each audio coding symbol is updated by frequency counting of symbols followed by re-normalization, which is computationally inefficient.

The use of static probability models for the arithmetic coding is often suboptimal due to non-stationary nature of audio data. Instead of a static model, one may consider the usage of an adaptive model that can adapt itself recursively. Therefore, it is desired to provide an efficient solution for audio coding that determines probability distribution (or CDF) for audio coding symbols adaptively.

According to example embodiments disclosed herein, there is provided an adaptive arithmetic coding of audio content where the probabilities of audio coding symbols are determined based on characteristic-based classification of the audio content, resulting in an improved coding efficiency and decreased complexity in both encoding and decoding processes.

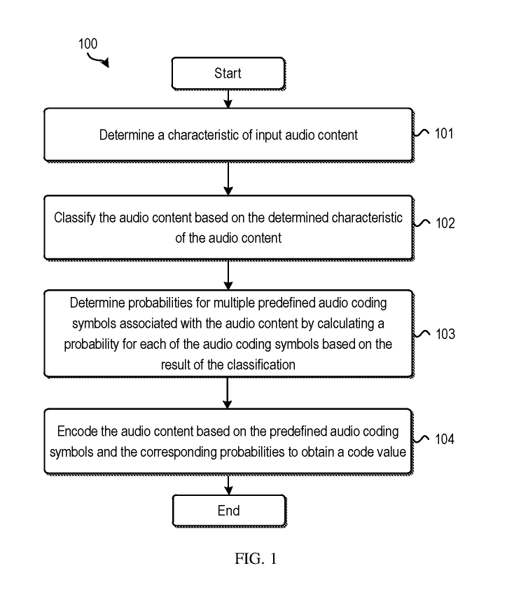

FIG. 1 depicts a flowchart of a method of encoding audio content 100 in accordance with an example embodiment disclosed herein. It should be noted that the audio content here may be of any type of audio, such as speech, music, noise, or their combination, and the like. In addition, the audio content may be of any time length, for example, a segment of a frame, a frame, or more than one frame, and the like. The scope of the subject matter disclosed herein is not limited in these regards.

As shown in FIG. 1, at step 101, a characteristic of input audio content is determined, where the characteristic of the audio content includes at least one of a type or a property of the audio content.

In example embodiments disclosed herein, it is desired to adapt the probability estimation in arithmetic coding based on the characteristic of the audio content. For example, for different types of audio content to be encoded, different probability sets that contain probabilities of audio coding symbols may be pre-trained for audio coding. For another example, depending on the property of the audio content, a different probability set may be pre-trained. Furthermore, both the type and property of the audio content may be taken into consideration when determining a probability set for the audio content.

In some example embodiments disclosed herein, the audio content property may include one or more of full band energy, sub-band energy, a spectral centroid, a spectral flux, or harmonicity of the audio content. In some example embodiments disclosed herein, the audio content type may include speech, music, noise, and the like. Some categories of audio content may be further classified into multiple subcategories. By way of example, the category of music may be further classified into blues music, rock music, and so on. The scope of the subject matter disclosed herein is not limited in these regards.

In some example embodiments disclosed herein, the input audio content may be processed to analyze its temporal and spectral properties, so as to determine the type or property of the audio content. For example, the input audio content represented in the time domain may be transformed into frequency domain representation using a time-frequency transform such as complex quadrature mirror filterbanks (CQMF), modified discrete cosine transform (MDCT)/modified discrete sine transform (MDST), modified complex lapped transform (MCLT), or the like. The full frequency range may be optionally divided into a plurality of frequency sub-bands, each of which occupies a predefined frequency range. The outputs of the processing may be time-frequency cells and characteristic determination may be performed for each time-frequency cell. In some other example embodiments disclosed herein, the characteristic determination may be performed for each frame of the audio content. For example, if the input audio content is to be determined as a speech type or a non-speech type, the characteristic determination may comprise voice activity detection (VAD) on each frame of the audio content.

At step 102, the audio content is classified based on the determined characteristic of the audio content.

The classified audio content may be classified into one or more categories. Any suitable audio content classification technique, either currently known or to be developed in the future, can be used. In some example embodiments disclosed herein, each category may be associated with a type of audio content. In some other example embodiments disclosed herein, each category may be associated with a certain property or a combination of the determined properties of the audio content. For example, the audio content may be classified into a category if its full band energy falls into the range of full band energy associated with the category. For another example, the classification result may be determined based on the combination of the full band energy and sub band energy. In further example embodiments, the classification result may be associated with a combination of the type and the properties of the audio content.

At step 103, probabilities for multiple predefined audio coding symbols associated with the audio content are determined by calculating a probability for each of the audio coding symbols based on the result of the classification.

As mentioned above, in arithmetic coding, multiple audio coding symbols may be predefined and their respective probabilities may be determined for encoding the input audio content. The audio coding symbols may represent the audio content in various ways according to the data sequence of the audio content to be encoded. In some embodiments, the audio content may be preprocessed, such as by noise reduction, leveling, and the like, to obtain gains of the audio content to be encoded. A gain may be a vector including multiple elements. For example, a gain may be a 48-dimensional vector in some speech systems, which may correspond to processing on a 20 ms basis. Therefore, the audio coding symbols may be constructed from the individual elements that occur in the obtained vectors in some examples, or may be constructed from the individual vectors that occur in the input audio content in some other examples. A sequence of elements or vectors obtained after preprocessing of the audio content is referred to as instances of the predefined audio coding symbols, and may be, in some way, used to represent the audio content.

Here is a simple example for illustration. If the sequence of symbols obtained after preprocessing of audio content is an integer sequence {2, 1, 0, 0, 1, 3}, there are four audio coding symbols “0,” “1,” “2,” and “3” associated with the audio content and six instances of audio coding symbols in the integer sequence.

In order to encode the audio content as a code value in an arithmetic coding method, probability for each of the audio coding symbols may be calculated based on the classification result in example embodiments disclosed herein. For example, respective probabilities of the four audio coding symbols “0,” “1,” “2,” and “3” may be calculated before encoding the data sequence {2, 1, 0, 0, 1, 3}. Based on different results of classification obtained, different probability sets may be determined.

The probability determination will be described in details below.

The method 100 proceeds to step 104, where the audio content is encoded based on the predefined audio coding symbols and the corresponding probabilities to obtain a code value.

As mentioned above, the audio content may be preprocessed, such as by noise reduction, leveling, and the like, to obtain gains (for example, gain vectors) to be encoded.

With probabilities corresponding to the predefined audio coding symbols determined, each vector of the audio content may be encoded as a code value, for example, based on Equations (2) and (4)-(6), in the case that the predefined audio coding symbols are different elements in the vectors of the audio content. In some other embodiments, a sequence of vectors may be encoded as a code value in the case that the predefined audio coding symbols are vectors occurred in the audio content.

It should be noted that many other methods for audio content encoding based on the determined probabilities can be utilized and the scope of the subject matter disclosed herein is not limited in this regard.

In example embodiments disclosed herein, input audio content of an audio encoding system may be continuously encoded according to the method 100 described above. In some example embodiments disclosed herein, the code value may be stored in local memory or an external storage device of the audio encoding system, or may be provided to an audio decoding system. In some example embodiments, the result of classification may also be passed to the corresponding audio decoding system to assist the probability determination at the decoding side. The scope of the subject matter disclosed herein is not limited in these regards.

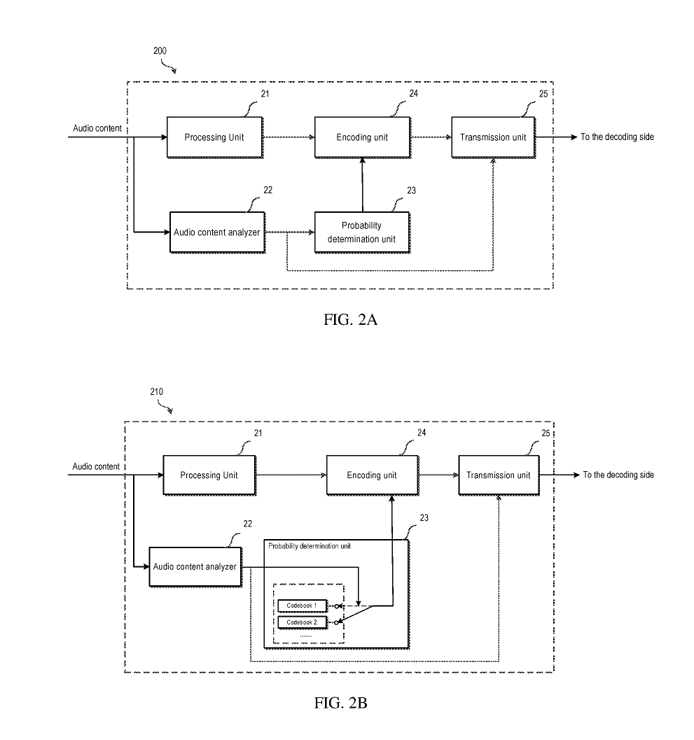

Reference is now made to FIG. 2A, which depicts a block diagram of an audio encoding system 200 in accordance with an example embodiment disclosed herein. As depicted, the system 200 comprises a processing unit 21, an audio content analyzer 22, a probability determination unit 23, an encoding unit 24, and a transmission unit 25.

The processing unit 21 is configured to receive input audio content and process the audio content to obtain information to be encoded by the encoding unit 24. For example, the processing unit 21 may perform noise reduction and leveling on the input audio content to obtain the data sequence (for example, gain vectors) to be encoded.

The audio content analyzer 22 is configured to analyze the input audio content, including determining a type and/or properties of the audio content and classifying the audio content based on the type and/or the properties. The classification result obtained by the audio content analyzer 22 is passed into the probability determination unit 23. In some example embodiments, the classification result may be optionally provided to the transmission unit 25.

The probability determination unit 23 is configured to determine probabilities for multiple predefined audio coding symbols associated with the audio content based on the classification result.

The encoding unit 24 obtains the data sequence of the audio content to be encoded from the processing unit 21 and their respective probabilities from the probability determination unit 23. The encoding unit 24 is configured to encode the data sequence of the audio content based on the predefined audio coding symbols and the corresponding probabilities to obtain a code value.

The code value determined by the encoding unit 24 is passed into the transmission unit 25. The transmission unit 25 is configured to transmit the code value and, in some example embodiments disclosed herein, the classification result to an audio decoding system.

It is appreciated that the audio encoding system 200 of FIG. 2A is shown as an example, and there can be additional or less functional blocks in the audio encoding system.

For example, an additional storage unit may be included in the system 200 to store the code value or other immediate information. In another example, the transmission unit 25 may be omitted if the code value is intended to be transmitted to the audio decoding system.

Now probability determination for multiple predefined audio coding symbols will be described in details. As discussed above, the probability determination is based on the classification result of the audio content.

In some example embodiments disclosed herein, multiple categories may be predetermined and the input audio content may be classified into one of the predetermined categories. In this case, a probability set may be pre-trained for each category offline. In each probability set, probabilities and/or CDFs for multiple predefined audio coding symbols are predetermined for the audio content classified into the corresponding category. The predetermined probabilities and/or CDFs may be different for various categories based on the different characteristics of the audio content. To this end, the predetermined probabilities may not be simply set to be equal to one another, but can be set as specific for different audio contents, which may improve the audio coding efficiency, for example, improve the compression ratio. When encoding input audio content, depending on which category the input audio content is classified into, the corresponding probability set may be selected and probabilities predetermined for this set may be used for encoding the input audio content.

For example, there are two categories of audio content, a speech category and a non-speech category, and two different probability sets are pre-trained for the two categories. When input audio content is classified as the speech category according to its characteristic, the probability set for the speech category may be selected and probabilities and/or CDFs predetermined in the probability set are used for encoding the input audio content.

Since the probability of each audio coding symbol indicates the frequency at which the audio coding symbol occurs in the audio content, if the audio coding symbol occurs frequently in the audio content, its probability may be increased accordingly and probabilities of other audio coding symbols may thus be decreased to make sure that the sum of probabilities for all audio coding symbols is 1. In some example embodiments disclosed herein, probabilities of the audio coding symbols may be updated according to the classification result of the audio content during the encoding process.

Specifically, an adaptation factor for the audio content may be determined based on the classification result, and then the probability for each of the audio coding symbols may be adapted based on the adaptation factor. The adaptation factor may be in a range of 0 to 1, indicating a rate at which the probability for each of the audio coding symbols changes. Based on a different classification result of the audio content, the adaptation factor may be different. For example, if the classification result indicates that the audio content is stationary, for example, the audio content is classified as a category of noise or blues music, the adaptation factor may be set as a high value, such that the change rate of the probabilities may be lower. If the classification result indicates that the audio content varies in a large range, for example, the audio content is classified as a category of rock music, the adaptation factor may be set as a low value, such that the change rate of the probabilities may be higher.

Every time the probabilities are updated, the sum of updated probabilities of all audio coding symbols should be guaranteed to be equal to 1. In addition, each of updated probabilities may be larger than 0. In one example embodiment disclosed herein, a minimum threshold and a maximum threshold for each of the probabilities may be configured, so that the probabilities may not become too small or too large during the updating process. For example, the minimum value of each probability may be set as probₘᵢₙ=4×10⁻⁵, and the maximum value of each probability may be set as probₘₐₓ=0.5. It will be appreciated that the minimum and maximum threshold may be configured as other values and the scope of the subject matter disclosed herein is not limited in this regard.

In some example embodiments disclosed herein, the initialized values for the probabilities of the audio coding symbols may be set as equal. Still take the data sequence {2, 1, 0, 0, 1, 3} as an example. Probability for each of the unique audio coding symbols “0,” “1,” “2,” and “3” in the sequence may be initialized, for example, as equal. That is, probability for each audio coding symbol is 0.25 since the sum of probabilities for all audio coding symbols should be 1.

In some other example embodiments where different probability sets are pre-trained for different categories of audio content, initialized values may be probability values in a probability set that is determined as being associated with the input audio content to be encoded.

During the updating process, for a given audio coding symbol, its probability may be increased based on the adaptation factor if the given audio coding symbol is detected in the audio content (that is, an instance of the given audio coding symbol occurs in the audio content), and its probability may be decreased based on the adaptation factor if the given audio coding symbol is not detected in the audio content. The updating process may be represented as below:

$${p}_{k} ( m ) = \{ \begin{matrix}α {p}_{k - 1} ( m ) + ( 1 - α ) & m = {s}_{k} \\ α {p}_{k - 1} ( m ) & otherwise\end{matrix} , \qquad ( 10 )$$

where α represents an adaptation factor that is in a range of 0 to 1, pₖ₋₁(m) represents probability of an audio coding symbol m when encoding the (k−1)-th symbol, sₖ₋₁, in a data sequence of audio content S={s₁, s₂, . . . , s_{N}}, and pₖ (m) represents the probability of the audio coding symbol m when encoding the k-th symbol, sₖ, in the data sequence of the audio content. In Equation (10), if an audio coding symbol m is detected in the audio content (for example, m=sₖ), its probability is increased as αpₖ₋₁(m)+(1−α); otherwise, its probability is decreased as αpₖ₋₁(m). Note that Equation (10) does not require a division to renormalize the probability mass function. This may lead to a computational advantage in some cases, as the multiplicative update in Equation (10) is cheaper than division operations required on many hardware platforms.

Suppose that the adaptation factor is 0.8. For the data sequence {2, 1, 0, 0, 1, 3}, in response to the first incoming audio coding symbol instance “2” in the sequence being detected, the probability for the corresponding audio coding symbol “2” in the predefined set of audio coding symbols {0, 1, 2, 3} is increased according to Equation (10) as:

p₁(2)=0.8p₀(2)+(1−0.8)=0.8×0.25+0.2=0.4. (11)

That is, the probability for “2” is increased to 0.4 from 0.25. Probabilities of other audio coding symbols 0, 1, 3 may be decreased as below based on the adaptation factor to make sure that the sum of all probabilities is equal to 1:

p₁(0)=0.8p₀(0)=0.8×0.25=0.2, (12)

p₁(1)=0.8p₀(1)=0.8×0.25=0.2, (13)

p₁(3)=0.8p₀(3)=0.8×0.25=0.2, (14)

That is, the probabilities for “0,” “1,” and “3” are all decreased to 0.2 from 0.25 when detecting the audio coding symbol instance “2” in the data sequence. In response to following instances of audio coding symbols in the sequence {1, 0, 0, 1, 3}, probabilities of the corresponding audio coding symbols may be similarly updated.

In some example embodiments disclosed herein, the adaptation factor may be a time-constant value in the range from 0 to 1. That is, for certain input audio content, the adaptation factor may be fixed. In the above example, the adaptation factor may be fixed to be 0.8 for the input audio content. In some example embodiments disclosed herein, the fixed adaptation factor may be determined based on a relatively long time of observation of the classification result. For example, if the classification result of the audio content in long time duration, for example, during multiple frames, indicates that the audio content is stationary, the adaptation factor may be set as a relatively high value in the range of 0 to 1.

In some example embodiments disclosed herein, the adaptation factor may be a time-variant value. For example, the adaptation factor may be determined frame by frame based on the classification result. A time-variant parameter may be introduced to control the change rate of the probabilities in time domain. For example, Equation (10) may be modified as below:

$${p}_{k} ( m ) = \{ \begin{matrix}α ρ {p}_{k - 1} ( m ) + ( 1 - αρ ) & m = {s}_{k} \\ α ρ {p}_{k - 1} ( m ) & otherwise\end{matrix} , \qquad ( 15 )$$

where αρ represents the adaptation factor, α represents a time-constant parameter determined from the classification result observed in relatively long time duration (during multiple frames, for example), and ρ represents a time-variant parameter determined from the classification result observed in a relatively short time duration (a frame, for example).

In some example embodiments disclosed herein, the time-constant or time-variant adaptation factor may be configured as desired. In some other example embodiments disclosed herein, the probabilities may be adapted using different adaptation factors and then the one giving the least length of code value may be chosen frame by frame.

In example embodiments where different probability sets are pre-trained for different categories of audio content, adaptation factors for the pre-trained probability sets may be determined respectively and may be different. When the corresponding probability set is chosen according to the classification result, probabilities predetermined for this probability set may be updated based on the respective adaptation factor, which may be represented as below:

$${p}_{k , i} ( m ) = \{ \begin{matrix}{α}_{i} {p}_{k - 1 , i} ( m ) + ( 1 - {α}_{i} ) & if {p}_{i} ( m ) is chosen and m = {s}_{k} \\ {α}_{i} {p}_{k - 1 , i} ( m ) & otherwise\end{matrix} , \qquad ( 16 )$$

where αᵢ represents an adaptation factor determined for the i-th probability set, i=1, 2, . . . , K, and K represents the total number of predetermined probability sets.

It can be understood from the above discussion that in some embodiments disclosed herein, only one probability set may be determined based on the classification of the audio content and then may be updated according to an adaptation factor. Alternatively, in some other embodiments disclosed herein, more than one probability set may be pre-trained for different categories of audio content and one set may be selected for encoding according to the classification result of input audio content. In these embodiments, the pre-trained probability sets may also be updated based on their respective adaptation factors.

FIG. 2B depicts a block diagram of an audio encoding system 210, which can be considered as an implementation of the system 200 described above. As shown, in the system 210, the probability determination unit 23 is implemented as a multiplexer configured to select one of the predetermined probability sets based on the classification result from the audio content analyzer 22. The selected probability set is provided to the encoding unit 24 for encoding input audio content.

The probability sets may be stored in the system 210 as codebooks. FIG. 2B shows two codebooks, namely, Codebook 1 and Codebook 2. It is to be understood that this is merely for the purpose of illustration, without suggesting any limitation as to the scope of the subject matter disclosed herein. Any suitable number of codebooks can be used. A codebook may be implemented, for example, as a database table, an Extensible Markup Language (XML) file, a plaintext file, or the like.

In some embodiments where audio content contains speech signals, an input frame of the audio content may be classified as a speech frame or a non-speech frame. In these embodiments, the audio content analyzer 22 may be implemented as a voice activity detection (VAD) block, and there may be two codebooks in the system 210 used for encoding the two categories of frames respectively. If the output of the audio content analyzer 22 indicates that the current frame is a speech frame or a non-speech frame, the probability determination unit 23, which functions as a multiplexer, may select a corresponding codebook for the encoding unit 24. The encoding unit 24 may encode the current frame based on the selected codebook to obtain a code value. In some embodiments, the code value may be transmitted to the decoding side by the transmission unit 25 together with the classification result of the VAD block 22. The classification result may, for example, be a 1-bit flag, indicating whether the current frame is a speech frame or a non-speech frame.

In some embodiments disclosed herein, respective probabilities in the multiple codebooks may be pre-trained in different ways for respective categories of audio content. In some other embodiments, probabilities in each of the codebooks may be initialized as equal for each audio coding symbol and may be updated frame by frame according to Equation (16). The adaptation factors used to update the codebooks may be different. For example, adaptation factors 0.99 and 0.90 may be set for the codebook used for encoding speech frames and the codebook used for encoding non-speech frames, respectively.

According to the probability determination described above, the computation cost can be reduced since probabilities are updated by simple multiplication and addition operations, avoiding the use of any division operation. Moreover, the updated probabilities may indicate the frequency at which respective audio coding symbols occur in the audio content more accurately, and thus the coding efficiency may be improved.

In some example embodiments disclosed herein, instead of the probabilities, cumulative distribution functions (CDFs) used for encoding audio content may be updated based on the classification result. In one embodiment, similar to Equation (10) used for updating the probabilities, CDFs may be updated based on a fixed adaptation factor determined from the classification result, which may be presented as below:

$${c}_{k} ( m ) = \{ \begin{matrix}α {c}_{k - 1} ( m ) + ( 1 - α ) & m \geq {s}_{k} \\ α {c}_{k - 1} ( m ) & otherwise\end{matrix} . \qquad ( 17 )$$

In another embodiment, similar to Equation (15) used for updating the probabilities, CDFs of the audio coding symbols may also be updated based on a time-variant adaptation factor, which may be presented as below:

$${c}_{k} ( m ) = \{ \begin{matrix}αρ {c}_{k - 1} ( m ) + ( 1 - αρ ) & m \geq {s}_{k} \\ αρ {c}_{k - 1} ( m ) & otherwise\end{matrix} . \qquad ( 18 )$$

The adaptation factor α or αρ may also be similarly determined based on the classification result of the audio content. Since CDFs may also have an impact on the code value of the audio content, with the updated CDFs, coding efficiency may also be improved. During the CDF updating, the sum of probabilities for all audio coding symbols may also be guaranteed to be equal to 1.

In some further embodiments disclosed herein, the probability determination may be further based on the context of the audio coding symbols in addition to the classification result of the audio content.

The term “context” of a given audio coding symbol here is used in its broad understanding. In some example embodiments disclosed herein, for a given audio coding symbol m=sₖ, its context may refer to one or more processed instances of audio coding symbols Sₖ₋₁={s₁, s₂, . . . , sₖ₋₁} before the instance of the given audio coding symbol m, and probabilities determined for their corresponding audio coding symbols respectively. The context of the audio coding symbols may alternatively or additionally include one or more of previous probabilities of the given audio coding symbol p₁(m), p₂(m), . . . , pₖ₋₁(m) determined when processing one or more of instances of audio coding symbols Sₖ₋₁={s₁, s₂, . . . , sₖ₋₁}.

A probabilistic model may be constructed based on the context of the audio coding symbol and parameter(s) dependent on the classification result of the audio content, such as the adaptation factor. In some example embodiments disclosed herein, the probabilistic model may be represented as pₖ(sₖ|Sₖ₋₁, Tₖ), where Sₖ₋₁ represents the previously processed instances of audio coding symbols occurring in the audio content and Tₖ represents the previously processed audio content. Using the Bayes rule to construct the probabilistic model, the following equations may be obtained:

$$\begin{matrix}{p}_{k} ( {s}_{k} \vert {S}_{k - 1} , {T}_{k} ) = {p}_{k} ( ( {s}_{k} \vert {S}_{k - 1} ) \vert {T}_{k} ) , & ( 19 ) \\ {p}_{k} ( ( {s}_{k} \vert {S}_{k - 1} ) \vert {T}_{k} ) = {p}_{k} ( {s}_{k} \vert {S}_{k - 1} ) \frac{{p}_{k} ( {T}_{k} \vert ( {s}_{k} \vert {S}_{k - 1} ) )}{{p}_{k} ( {T}_{k} )} . & ( 20 )\end{matrix}$$

Assuming that

pₖ(Tₖ|(sₖ|Sₖ₋₁))=pₖ(Tₖ|sₖ), (21)

the probabilistic model may be determined as:

$${p}_{k} ( {s}_{k} \vert {S}_{k - 1} , {T}_{k} ) = {p}_{k} ( {s}_{k} \vert {S}_{k - 1} ) \frac{{p}_{k} ( {s}_{k} \vert {T}_{k} )}{{p}_{k} ( {s}_{k} )} , \qquad ( 22 )$$

where pₖ(sₖ|Sₖ₋₁) represents a probabilistic model dependent on the context of the audio coding symbol Sₖ₋₁, pₖ(sₖ|Tₖ) represents a probabilistic model dependent on the audio content, for example, the classification result of the audio content, and pₖ(sₖ) represents the unigram model.

In some example embodiments disclosed herein, some existing context-based probability estimation methods may be used to determine the probabilistic model pₖ(sₖ|Sₖ₋₁). The probabilistic model pₖ(sₖ|Tₖ) may be determined according to some example embodiments discussed above with respect to the probabilistic determination and updating based on the classification result. pₖ(sₖ) may be determined as the initialized probability value of the instance of the audio coding symbol sₖ.

It is appreciated that the probabilistic model used to determine the probabilities of audio coding symbols is given above as an example, and there are many other ways to construct the probabilistic model based on a combination of the context and the classification result. The scope of the subject matter disclosed herein is not limited in this regard.

In some further example embodiments disclosed herein, the audio coding symbols can be sorted in a descending order of their probabilities. For example, the audio coding symbols can be sorted from the highest probability to the lowest one every pre-defined seconds (or frames). As discussed above, there is correspondence between the audio coding symbols and their probabilities. When encoding a data sequence obtained from input audio content based on the set of predefined audio coding symbols and their probabilities, for a given symbol in the data sequence, the audio coding symbol associated with the give symbol is searched from the set of audio coding symbols, and then the corresponding probability is obtained for encoding. Putting audio coding symbols that have high probabilities at the beginning of the set can significantly reduce the searching time when encoding the audio content, especially when there are a large amount of predefined audio coding symbols.

In the above description, the probability determination at the encoding side is described. Based on the determined probability, input audio content may be encoded as a code value. The code value may be provided to an audio decoding system to use for decoding the audio content. As mentioned above, in the arithmetic coding algorithm, the decoding process is similar to the encoding process, during which the probabilities may also be estimated for decoding. In order to accurately decode the audio content, it is desired that the estimated probabilities for the audio coding symbols are substantially equal to that estimated at the encoding side. To this end, the classification result on which the probability estimation depends should maintain consistency at both encoding and decoding sides, as well as the context of the audio coding symbols.

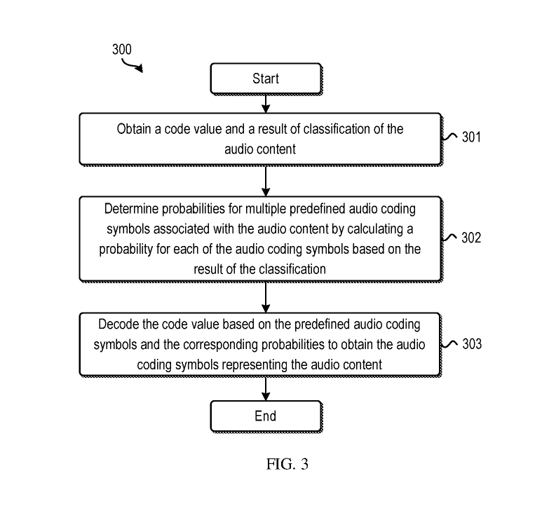

FIG. 3 depicts a flowchart of a method of decoding audio content 300 in accordance with an example embodiment disclosed herein.

As shown in FIG. 3, at step 301, a code value and a result of classification of the audio content are obtained. The code value represents a compression coding format of the audio content and may be obtained from the audio encoding system directly or from a storage device.

The classification result, similar as in the audio encoding system, may be determined based on a characteristic of the audio content including at least one of a type or a property of the audio content. The classification result, also similar as in the audio encoding system, may be used for determining probabilities for predefined audio coding symbols.

In order to facilitate accurate probability determination, the classification result should be substantially the same as that determined at the encoding side. To this end, the classification result may be obtained directly from the audio encoding system in some example embodiments disclosed herein. Information indicating the classification result may be transmitted from the audio encoding system and received by the audio decoding system. For example, as depicted in the audio encoding system 200 of FIG. 2A, the classification result determined by the audio content analyzer 22 is passed into the transmission unit 25, and then is provided to the audio decoding system.

In some other example embodiments disclosed herein, the classification result may be obtained by classifying the audio content according to the characteristic of the audio content determined based on the past audio content available to the audio decoding system, for example a decoded portion of the audio content. For example, if a portion of the audio content has been decoded successfully, this portion of audio content may be classified based on the determined characteristic of the audio content. The characteristic may be obtained from the audio encoding system or by analyzing the past audio content.

At step 302 of the method 300, probabilities for multiple predefined audio coding symbols associated with the audio content are determined by calculating a probability for each of the audio coding symbols based on the result of the classification.

The probability determination process in the audio decoding system is similar to that in the audio encoding system, and the detailed description will be omitted here for the sake of clarity. It will be appreciated that in example embodiments of updating the probabilities, for a given audio coding symbol, the probability for the given audio coding symbol is increased based on the adaptation factor if the given audio coding symbol is decoded by the audio decoding system, and is decreased based on the adaptation factor if the given audio coding symbol is not decoded by the audio decoding system.

The predefined audio coding symbols in the audio decoding system may also be sorted in a descending order of the corresponding probabilities so as to reduce the time of searching the audio coding symbol set when decoding the audio content.

At step 303, the code value is decoded based on the predefined audio coding symbols and the corresponding probabilities to obtain audio coding symbols representing the audio content.

With probabilities for the audio coding symbols determined, the code value may be decoded as a data sequence representing the audio content, for example, based on Equations (7)-(9). The decoded data sequence may include instances of audio coding symbols that are the same or substantially the same as those obtained at the encoding side, which may represent the audio content. It is noted that there are many other methods to decode the code value by use of the determined probabilities, and the scope of the subject matter disclosed herein is not limited in this regard.

As the decoded data sequence is in digital representation, by subsequent processing of the data sequence, for example, by digital-to-analog conversion and the like, the decoded audio signal may be derived and then, for example, playback through loudspeakers.

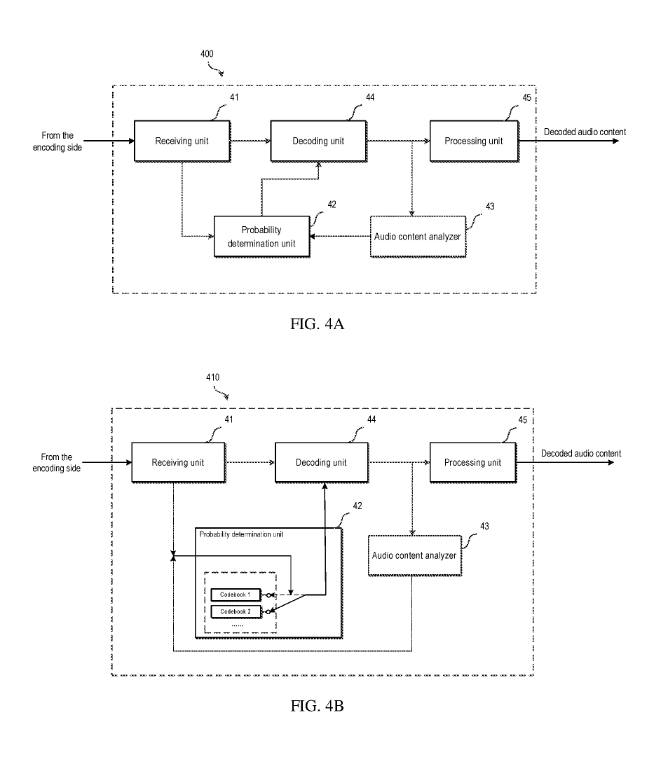

Reference is now made to FIG. 4A, which depicts a block diagram of an audio decoding system 400 in accordance with an example embodiment disclosed herein. As depicted, the system 400 comprises a receiving unit 41, a probability determination unit 42, an audio content analyzer 43, a decoding unit 44, and a processing unit 45.

The receiving unit 41 is configured to receive a code value to be decoded from an audio encoding system and provide it to the decoding unit 44. In some example embodiments disclosed herein, the receiving unit 41 is also configured to receive the result of classification of the audio content from the audio encoding system and pass it into the probability determination unit 42.

The probability determination unit 42 is configured to determine probabilities for multiple predefined audio coding systems based on the classification result. The classification result may be obtained from the receiving unit 41 in some example embodiments disclosed herein, or from the audio content analyzer 43 in some other example embodiment disclosed herein.

The audio content analyzer 43 is an optional function block in the audio decoding system 400. In example embodiments where the classification result is not provided by the audio encoding system, the audio content analyzer 43 is configured to determine which category the audio content is classified into based on the decoding result from the decoding unit 44. In example embodiments where the classification result is provided by the audio encoding system, the audio content analyzer 43 may stop operation.

The decoding unit 44 is configured to decode the code value to obtain a data sequence representing audio content based on the predefined audio coding symbols and their respective probabilities from the probability determination unit 42.

The processing unit 45 is configured to process the obtained data sequence, for example by digital-to-analog conversion and the like, to obtain the decoded audio content.

It is appreciated that the audio decoding system 400 of FIG. 4A is shown as an example, and there can be additional or less functional blocks in the audio decoding system. For example, an additional storage unit may be included in the audio decoding system 400 to store the decoded data sequence or the audio content. In another example, the audio content analyzer 43 may be omitted if the classification result is provided by the audio encoding system.

In accordance with embodiments disclosed herein, the audio decoding system 400 may have a variety of implementations or variations to achieve consistent probability determination with the audio encoding side. FIG. 4B depicts a block diagram of an audio decoding system 410, which can be considered as an implementation of the system 400 described above. As shown, in the system 410, the probability determination unit 42 is implemented as a multiplexer configured to select one of the predetermined probability sets based on the classification result provided by the receiving unit 41 and/or the audio content analyzer 43. The selected probability set is provided to the decoding unit 44 for decoding the received code value.

The probability sets may be stored in the system 410 as codebooks. FIG. 4B shows two codebooks, namely, Codebook 1 and Codebook 2. It is to be understood that this is merely for the purpose of illustration, without suggesting any limitation as to the scope of the subject matter disclosed herein. Any suitable number of codebooks can be used. A codebook may be implemented, for example, as a database table, an Extensible Markup Language (XML) file, a plaintext file, or the like.

In some embodiments where the audio content contains speech signals, a frame of the audio content to be decoded may be a speech frame or a non-speech frame. In these embodiments, a 1-bit flag may be received from the encoding side, indicating whether the current frame is a speech frame or a non-speech frame. In the case where the classification result is not provided by the encoding side, the audio content analyzer 43 may operate as a voice activity detection (VAD) block to determine the classification result for probability determination. In these embodiments, there may be two codebooks in the system 410 used for decoding the two categories of frames respectively. If the received classification result or the output of the audio content analyzer 43 indicates that the current frame is a speech frame or a non-speech frame, the probability determination unit 42, which functions as a multiplexer, may select a corresponding codebook for the decoding unit 44. The decoding unit 44 may decode the code value of the current frame based on the selected codebook.

In some embodiments disclosed herein, respective probabilities in the multiple codebooks may be pre-trained in different ways for respective categories of audio content. In some other embodiments, the probabilities in each of the codebooks may be initialized as equal for each audio coding symbol and may be updated frame by frame according to Equation (16). The adaptation factors used to update the codebooks may be consistent with those used at the encoding side. For example, if adaptation factors 0.99 and 0.90 are set in the encoding system 210 for the codebook used for decoding speech frames and the codebook used for decoding non-speech frames, respectively, the same adaptation factors should be used in the decoding system 410.

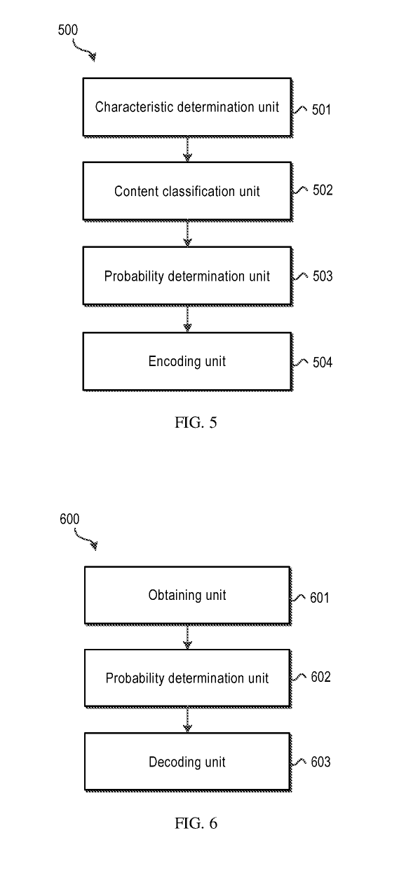

FIG. 5 depicts a block diagram of a system of encoding audio content 500 in accordance with one example embodiment disclosed herein. As depicted, the system 500 comprises a characteristic determination unit 501 configured to determine a characteristic of the audio content, the characteristic of the audio content including at least one of a type or a property of the audio content. The system 500 also comprises a content classification unit 502 configured to classify the audio content based on the determined characteristic of the audio content and a probability determination unit 503 configured to determine probabilities for multiple predefined audio coding symbols associated with the audio content by calculating a probability for each of the audio coding symbols based on the result of the classification, the probability for an audio coding symbol indicating a frequency at which the audio coding symbol occurs in the audio content. The system 500 further comprises an encoding unit 504 configured to encode the audio content based on the predefined audio coding symbols and the corresponding probabilities to obtain a code value, the code value representing a compression coding format of the audio content.

In some embodiments disclosed herein, the audio content may be classified based on the property of the audio content, the property of the audio content including at least one of full band energy, sub-band energy, a spectral centroid, a spectral flux, or harmonicity of the audio content.

In some embodiments disclosed herein, the probability determination unit 503 may be further configured to calculate the probability for each of the audio coding symbols further based on a context of the audio coding symbol.

In some embodiments disclosed herein, the probability determination unit 503 may be further configured to determine an adaptation factor for the audio content based on the result of the classification, the adaptation factor indicating a rate at which the probability for each of the audio coding symbols changes, and adapt the probability for each of the audio coding symbols based on the adaptation factor.

In some embodiments disclosed herein, the probability determination unit 503 may be further configured to for a given audio coding symbol, increase the probability for the given audio coding symbol based on the adaptation factor if the given audio coding symbol is detected in the audio content, and decrease the probability for the given audio coding symbol based on the adaptation factor if the given audio coding symbol is not detected in the audio content.

In some embodiments disclosed herein, the system 500 may further comprise a symbol sorting unit configured to sort the predefined audio coding symbols in a descending order of the corresponding probabilities. In these embodiments, the encoding unit 504 may be configured to encode the audio content based on the sorted audio coding symbols and the corresponding probabilities.

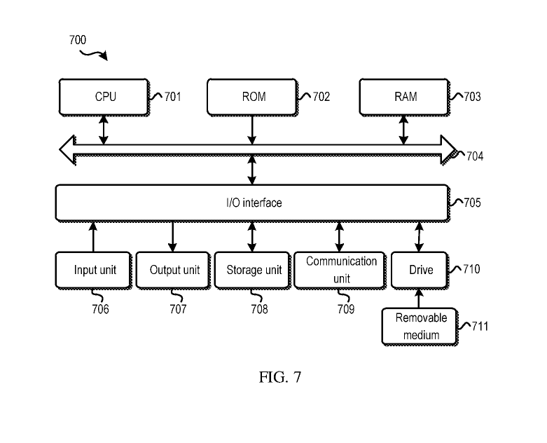

FIG. 6 depicts a block diagram of a system of decoding audio content 600 in accordance with one example embodiment disclosed herein. As depicted, the system 600 comprises an obtaining unit 601 configured to obtain a code value and a result of classification of the audio content, the code value representing a compression coding format of the audio content, the result of the classification being determined based on a characteristic of the audio content including at least one of a type or a property of the audio content. The system 600 also comprises a probability determination unit 602 configured to determine probabilities for multiple predefined audio coding symbols associated with the audio content by calculating a probability for each of the audio coding symbols based on the result of the classification, the probability for an audio coding symbol indicating a frequency at which the audio coding symbol occurs in the audio content. The system 600 further comprises a decoding unit 603 configured to decode the code value based on the predefined audio coding symbols and the corresponding probabilities to obtain audio coding symbols representing the audio content.

In some embodiments disclosed herein, the result of the classification may be obtained by receiving indication information indicating the result of the classification from an audio encoding system that provides the code value.

In some embodiments disclosed herein, the result of the classification may be obtained by classifying the audio content according to the characteristic of the audio content determined based on a decoded portion of the audio content.

In some embodiments disclosed herein, the property of the audio content may include at least one of full band energy, sub-band energy, a spectral centroid, a spectral flux, or harmonicity of the audio content.

In some embodiments disclosed herein, the probability determination unit 602 may be further configured to calculate the probability for each of the audio coding symbols further based on a context of the audio coding symbol.

In some embodiments disclosed herein, the probability determination unit 602 may be further configured to determine an adaptation factor for the audio content based on the result of the classification, the adaptation factor indicating a rate at which the probability for each of the audio coding symbols changes, and adapt the probability for each of the audio coding symbols based on the adaptation factor.

In some embodiments disclosed herein, the probability determination unit 602 may be further configured to for a given audio coding symbol, increase the probability for the given audio coding symbol based on the adaptation factor if the given audio coding symbol is decoded, and decrease the probability for the given audio coding symbol based on the adaptation factor if the given audio coding symbol is not decoded.

In some embodiments disclosed herein, the system 600 may further comprise a symbol sorting unit configured to sort the predefined audio coding symbols in a descending order of the corresponding probabilities. In these embodiments, the decoding unit 603 may be configured to decode the code value based on the sorted audio coding symbols and the corresponding probabilities.

For the sake of clarity, some optional components of the system 500 are not shown in FIG. 5, and some optional components of the system 600 are not shown in FIG. 6. However, it should be appreciated that the features as described above with reference to FIGS. 1-2B are all applicable to the system 500, and the features as described above with reference to FIGS. 3-4B are all applicable to the system 600. Moreover, the components of the system 500 or 600 may be a hardware module or a software unit module. For example, in some embodiments, the system 500 or 600 may be implemented partially or completely as software and/or in firmware, for example, implemented as a computer program product embodied in a computer readable medium. Alternatively or additionally, the system 500 or 600 may be implemented partially or completely based on hardware, for example, as an integrated circuit (IC), an application-specific integrated circuit (ASIC), a system on chip (SOC), a field programmable gate array (FPGA), and so forth. The scope of the subject matter is not limited in this regard.

FIG. 7 depicts a block diagram of an example computer system 700 suitable for implementing example embodiments disclosed herein. In some example embodiments, the computer system 700 may be suitable for implementing the method of encoding audio content, or suitable for implementing the method of decoding audio content. In some example embodiments, the computer system 700 may be suitable for implementing both the method of encoding audio content and the method of decoding audio content.

As depicted, the computer system 700 comprises a central processing unit (CPU) 701 which is capable of performing various processes in accordance with a program stored in a read only memory (ROM) 702 or a program loaded from a storage unit 708 to a random access memory (RAM) 703. In the RAM 703, data required when the CPU 701 performs the various processes or the like is also stored as required. The CPU 701, the ROM 702 and the RAM 703 are connected to one another via a bus 704. An input/output (I/O) interface 705 is also connected to the bus 704.

The following components are connected to the I/O interface 705: an input unit 706 including a keyboard, a mouse, or the like; an output unit 707 including a display such as a cathode ray tube (CRT), a liquid crystal display (LCD), or the like, and a loudspeaker or the like; the storage unit 708 including a hard disk or the like; and a communication unit 709 including a network interface card such as a LAN card, a modem, or the like. The communication unit 709 performs a communication process via the network such as the internet. A drive 710 is also connected to the I/O interface 705 as required. A removable medium 711, such as a magnetic disk, an optical disk, a magneto-optical disk, a semiconductor memory, or the like, is mounted on the drive 710 as required, so that a computer program read therefrom is installed into the storage unit 708 as required.

Specifically, in accordance with example embodiments disclosed herein, the processes described above with reference to FIGS. 1 and 3 may be implemented as computer software programs. For example, example embodiments disclosed herein comprise a computer program product including a computer program tangibly embodied on a machine readable medium, the computer program including program code for performing the method 100 and/or the method 300. In such embodiments, the computer program may be downloaded and mounted from the network via the communication unit 709, and/or installed from the removable medium 711.

Generally speaking, various example embodiments disclosed herein may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments disclosed herein are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, example embodiments disclosed herein include a computer program product comprising a computer program tangibly embodied on a machine readable medium, the computer program containing program codes configured to carry out the methods as described above.

In the context of the disclosure, a machine readable medium may be any tangible medium that can contain, or store a program for use by or in connection with an instruction execution system, apparatus, or device. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods disclosed herein may be written in any combination of one or more programming languages. These computer program codes may be provided to a processor of a general purpose computer, special purpose computer, or other programmable data processing apparatus, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server. The program code may be distributed on specially-programmed devices which may be generally referred to herein as “modules”. Software component portions of the modules may be written in any computer language and may be a portion of a monolithic code base, or may be developed in more discrete code portions, such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. Further, it is well known to the skilled person that communication media typically embodies computer readable instructions, data structures, program modules or other data in a modulated data signal such as a carrier wave or other transport mechanism and includes any information delivery media.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter disclosed herein or of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination.

Various modifications, adaptations to the foregoing example embodiments disclosed herein may become apparent to those skilled in the relevant arts in view of the foregoing description, when read in conjunction with the accompanying drawings. Any and all modifications will still fall within the scope of the non-limiting and example embodiments disclosed herein. Furthermore, other embodiments disclosed herein will come to mind to one skilled in the art to which these embodiments pertain having the benefit of the teachings presented in the foregoing descriptions and the drawings.

Accordingly, the present subject matter may be embodied in any of the forms described herein. For example, the following enumerated example embodiments (EEEs) describe some structures, features, and functionalities of some aspects of the subject matter.

EEE 1. A method of encoding audio content comprising: determining a characteristic of the audio content, the characteristic of the audio content including at least one of a type or a property of the audio content; classifying the audio content based on the determined characteristic of the audio content; determining probabilities for multiple predefined audio coding symbols associated with the audio content by calculating a probability for each of the audio coding symbols based on the result of the classification, the probability for an audio coding symbol indicating a frequency at which the audio coding symbol occurs in the audio content; and encoding the audio content based on the predefined audio coding symbols and the corresponding probabilities to obtain a code value, the code value representing a compression coding format of the audio content.

EEE 2. The method according to EEE 1, the audio content is classified based on the property of the audio content, the property of the audio content including at least one of full band energy, sub-band energy, a spectral centroid, a spectral flux, or harmonicity of the audio content.

EEE 3. The method according to EEE 1, determining probabilities for the predefined audio coding symbols comprises calculating the probability for each of the audio coding symbols further based on a context of the audio coding symbol.

EEE 4. The method according to any one of EEEs 1 to 3, determining probabilities for the predefined audio coding symbols further comprises: determining an adaptation factor for the audio content based on the result of the classification, the adaptation factor indicating a rate at which the probability for each of the audio coding symbols changes; and adapting the probability for each of the audio coding symbols based on the adaptation factor.

EEE 5. The method according to EEE 4, the adaptation factor is a time-constant value, and is in a range of 0 to 1.

EEE 6. The method according to EEE 4, the adaptation factor is a time-variant value, and is in a range of 0 to 1.

EEE 7. The method according to EEE 4, adapting the probability for each of the audio coding symbols based on the adaptation factor comprises: for a given audio coding symbol, increasing the probability for the given audio coding symbol based on the adaptation factor if the given audio coding symbol is detected in the audio content, and decreasing the probability for the given audio coding symbol based on the adaptation factor if the given audio coding symbol is not detected in the audio content.

EEE 8. The method according to EEE 1, the method further comprises sorting the predefined audio coding symbols in a descending order of the corresponding probabilities; and encoding the audio content based on the predefined audio coding symbols and the corresponding probabilities comprises encoding the audio content based on the sorted audio coding symbols and the corresponding probabilities.

EEE 9. A method of decoding audio content comprising: obtaining a code value and a result of classification of the audio content, the code value representing a compression coding format of the audio content, the result of the classification being determined based on a characteristic of the audio content including at least one of a type or a property of the audio content; determining probabilities for multiple predefined audio coding symbols associated with the audio content by calculating a probability for each of the audio coding symbols based on the result of the classification, the probability for an audio coding symbol indicating a frequency at which the audio coding symbol occurs in the audio content; and decoding the code value based on the predefined audio coding symbols and the corresponding probabilities to obtain audio coding symbols representing the audio content.

EEE 10. The method according to EEE 9, the result of the classification is obtained by receiving indication information indicating the result of the classification from an encoding system, the encoding system providing the code value.

EEE 11. The method according to EEE 9, the result of the classification is obtained by classifying the audio content according to the characteristic of the audio content determined based on a decoded portion of the audio content.

EEE 12. The method according to EEE 9, the property of the audio content includes at least one of full band energy, sub-band energy, a spectral centroid, a spectral flux, or harmonicity of the audio content.

EEE 13. The method according to EEE 9, determining probabilities for the predefined audio coding symbols comprises calculating the probability for each of the audio coding symbols further based on a context of the audio coding symbol.

EEE 14. The method according to any one of EEEs 9 to 13, determining probabilities for multiple predefined audio coding symbols associated with the audio content further comprises: determining an adaptation factor for the audio content based on the result of the classification, the adaptation factor indicating a rate at which the probability for each of the audio coding symbols changes; and adapting the probability for each of the audio coding symbols based on the adaptation factor.

EEE 15. The method according to EEE 14, the adaptation factor is a time-constant value, and is in a range of 0 to 1.

EEE 16. The method according to EEE 14, the adaptation factor is a time-variant value, and is in a range of 0 to 1.

EEE 17. The method according to EEE 14, adapting the probability for each of the audio coding symbols based on the adaptation factor comprises for a given audio coding symbol, increasing the probability for the given audio coding symbol based on the adaptation factor if the given audio coding symbol is decoded, and decreasing the probability for the given audio coding symbol based on the adaptation factor if the given audio coding symbol is not decoded.

EEE 18. The method according to EEE 9, the method further comprises sorting the predefined audio coding symbols in a descending order of the corresponding probabilities; and decoding the code value based on the predefined audio coding symbols and the corresponding probabilities comprises decoding the code value based on the sorted audio coding symbols and the corresponding probabilities.

It will be appreciated that the embodiments of the subject matter are not to be limited to the specific embodiments disclosed and that modifications and other embodiments are intended to be included within the scope of the appended claims. Although specific terms are used herein, they are used in a generic and descriptive sense only and not for purposes of limitation.

1. A method of encoding audio content comprising:
determining a characteristic of the audio content, the characteristic of the audio content including at least one of a type or a property of the audio content;
classifying the audio content based on the determined characteristic of the audio content;
determining probabilities for multiple predefined audio coding symbols associated with the audio content by calculating a probability for each of the predefined audio coding symbols based on the result of the classification, the probability for an audio coding symbol indicating a frequency at which the audio coding symbol occurs in the audio content; and
encoding the audio content based on the predefined audio coding symbols and the corresponding probabilities to obtain a code value, the code value representing a compression coding format of the audio content.

2. The method according to claim 1, wherein the audio content is classified based on the property of the audio content, the property of the audio content including at least one of full band energy, sub-band energy, a spectral centroid, a spectral flux, or harmonicity of the audio content.

3. The method according to claim 1, wherein determining the probabilities for the predefined audio coding symbols comprises:
calculating the probability for each of the audio coding symbols further based on a context of the audio coding symbol.

4. The method according to claim 1, wherein determining the probabilities for the predefined audio coding symbols further comprises:
determining an adaptation factor for the audio content based on the result of the classification, the adaptation factor indicating a rate at which the probability for each of the audio coding symbols changes; and
adapting the probability for each of the audio coding symbols based on the adaptation factor.

5. The method according to claim 4, wherein adapting the probability for each of the audio coding symbols based on the adaptation factor comprises:
for a given audio coding symbol,
increasing the probability for the given audio coding symbol based on the adaptation factor if the given audio coding symbol is detected in the audio content; and
decreasing the probability for the given audio coding symbol based on the adaptation factor if the given audio coding symbol is not detected in the audio content.

6. The method according to claim 1, further comprising:
sorting the predefined audio coding symbols in a descending order of the corresponding probabilities; and
wherein encoding the audio content based on the predefined audio coding symbols and the corresponding probabilities comprises:
encoding the audio content based on the sorted audio coding symbols and the corresponding probabilities.

7. A method of decoding audio content comprising:
obtaining a code value and a result of classification of the audio content, the code value representing a compression coding format of the audio content, the result of the classification being determined based on a characteristic of the audio content including at least one of a type or a property of the audio content;
determining probabilities for multiple predefined audio coding symbols associated with the audio content by calculating a probability for each of the predefined audio coding symbols based on the result of the classification, the probability for an audio coding symbol indicating a frequency at which the audio coding symbol occurs in the audio content; and
decoding the code value based on the predefined audio coding symbols and the corresponding probabilities to obtain audio coding symbols representing the audio content.

8. The method according to claim 7, wherein the result of the classification is obtained by receiving indication information indicating the result of the classification from an encoding system, the encoding system providing the code value.

9. The method according to claim 7, wherein the result of the classification is obtained by classifying the audio content according to the characteristic of the audio content determined based on a decoded portion of the audio content.

10. The method according to claim 7, wherein the property of the audio content includes at least one of full band energy, sub-band energy, a spectral centroid, a spectral flux, or harmonicity of the audio content.

11. The method according to claim 7, wherein determining the probabilities for the predefined audio coding symbols comprises:
calculating the probability for each of the audio coding symbols further based on a context of the audio coding symbol.

12. The method according to claim 7, wherein determining the probabilities for the predefined audio coding symbols further comprises:
determining an adaptation factor for the audio content based on the result of the classification, the adaptation factor indicating a rate at which the probability for each of the audio coding symbols changes; and
adapting the probability for each of the audio coding symbols based on the adaptation factor.

13. The method according to claim 12, wherein adapting the probability for each of the audio coding symbols based on the adaptation factor comprises:
for a given audio coding symbol,
increasing the probability for the given audio coding symbol based on the adaptation factor if the given audio coding symbol is decoded; and
decreasing the probability for the given audio coding symbol based on the adaptation factor if the given audio coding symbol is not decoded.

14. The method according to claim 7, further comprising:
sorting the predefined audio coding symbols in a descending order of the corresponding probabilities; and
wherein decoding the code value based on the predefined audio coding symbols and the corresponding probabilities comprises:
decoding the code value based on the sorted audio coding symbols and the corresponding probabilities.

15. A system of encoding audio content comprising:
a characteristic determination unit configured to determine a characteristic of the audio content, the characteristic of the audio content including at least one of a type or a property of the audio content;
a content classification unit configured to classify the audio content based on the determined characteristic of the audio content;
a probability determination unit configured to determine probabilities for multiple predefined audio coding symbols associated with the audio content by calculating a probability for each of the predefined audio coding symbols based on the result of the classification, the probability for an audio coding symbol indicating a frequency at which the audio coding symbol occurs in the audio content; and
an encoding unit configured to encode the audio content based on the predefined audio coding symbols and the corresponding probabilities to obtain a code value, the code value representing a compression coding format of the audio content.

16-28. (canceled)

29. A computer program product of encoding audio content, comprising a computer program tangibly embodied on a machine readable medium, the computer program containing program code for performing the method according to claim 1.

30. A computer program product of decoding audio content, comprising a computer program tangibly embodied on a machine readable medium, the computer program containing program code for performing the method according to claim 7.
